(19) United States
(12) Patent Application Publication
(10) Pub. No.: US 2024/0384861 A1
(43) Pub. Date: Nov. 21, 2024

(54) DOWNLIGHT HAVING DIRECT-PRESS ASSEMBLING MECHANISM

(71) Applicant: Xiamen PVTECH Co., Ltd., Xiamen (CN)

(72) Inventors: HAIBO HONG, Xiamen (CN); FUXING LU, Xiamen (CN)

(73) Assignee: Xiamen PVTECH Co., Ltd., Xiamen (CN)

(21) Appl. No.: 18/232,352

(22) Filed: Aug. 9, 2023

(30) Foreign Application Priority Data
May 16, 2023 (CN) 202310551370.3

(51) Int. Cl. F21V 17/06; F21S 8/02; F21V 19/00; F21V 23/00

(52) U.S. Cl. CPC F21V 17/06; F21S 8/026; F21V 17/166; F21V 19/003; F21V 23/002; F21V 29/87; F21Y 2105/18

(57) ABSTRACT

A downlight having direct-press assembling mechanism includes a housing, a light source board, a light cover and a plurality of spring fastening members. The housing has a cylindrical body, an opening disposed at one end of the cylindrical body and a plurality of fixing portions disposed on the outer wall of the cylindrical body. The light source board is disposed inside the cylindrical body. The light cover is disposed on the cylindrical body to cover the opening. The two ends of each of the spring fastening members is provided with a supporting portion and a locking portion respectively. The supporting portion is combined with the fixing portion corresponding thereto after a force is applied to directly press the supporting portion toward the fixing portion corresponding thereto. The above structure can reduce the difficulty of the assembling process and increase the work efficiency in order to decrease the manpower cost.

### BACKGROUND OF THE INVENTION

### 1. Field of the Invention

The present invention relates to a downlight, in particular to a downlight having direct-pressing assembling mechanism.

### 2. Description of the Prior Art

Downlights are installed in homes and various buildings. At present, a currently available embedded-type plastic downlight is usually assembled via torsion spring buckles, which tends to damage the hands of the user. Besides, the assembling process of the downlight wastes a lot of time, which significantly increases the manpower cost of the downlight.

### SUMMARY OF THE INVENTION

Therefore, it is a primary objective of the present invention to provide a downlight having direct-press assembling mechanism so as to solve the problems of prior art. The downlight includes a housing, a light source board, a light cover and a plurality of spring fastening members. The housing has a cylindrical body, an opening disposed at one end of the cylindrical body and a plurality of fixing portions disposed on the outer wall of the cylindrical body. The light source board is disposed inside the cylindrical body. The light cover is disposed on the cylindrical body to cover the opening. The two ends of each of the spring fastening members is provided with a supporting portion and a locking portion respectively. The supporting portion is combined with the fixing portion corresponding thereto after a force is applied to directly press the supporting portion toward the fixing portion corresponding thereto.

In one embodiment of the present invention, each of the spring fastening members is provided with a winding portion disposed between the supporting portion and the locking portion thereof.

In one embodiment of the present invention, the fixing portion has a protrusion block, a vertical locking slot disposed at the protrusion block and an assembling inlet. The assembling inlet is connected to the vertical locking slot.

In one embodiment of the present invention, the protrusion block has a stopper extending into the vertical locking slot, and the supporting portion has two vertical bars and a horizontal bar connected to one end of each of the two vertical bars. The horizontal bar is engaged with the stopper.

In one embodiment of the present invention, the width of a portion, for accommodating the stopper, of the vertical locking slot is less than a width of the horizontal bar.

In one embodiment of the present invention, the stopper has an inclined surface and a stopper surface. The inclined surface is able to guide the horizontal bar to reach the stopper surface and the stopper surface is vertical to an inserting direction of the horizontal bar.

In one embodiment of the present invention, the downlight further includes an output cable and a fastening strip. The housing has an accommodating portion and the output cable penetrates through the cable hole of the accommodating portion to connect to the light source board. The fastening strip is disposed in the accommodating portion to fix the output cable in the accommodating portion.

In one embodiment of the present invention, the housing includes a first ring portion and a second ring portion connected to each other. The cylindrical body is disposed between the first ring portion and the second ring portion, such that an accommodating space is formed between the first ring portion, the cylindrical body and the second ring portion.

In one embodiment of the present invention, the light source board is fixed on the inner surface of the second ring portion and the light source board is disposed in the accommodating space. A portion of the light source board is covered by the second ring portion and the other portion of the light source board is exposed from the second ring portion.

In one embodiment of the present invention, the housing is made of heat-conducting nylon material.

To sum up, according to the downlight having direct-press assembling mechanism of one embodiment of the present invention, the spring fastening members can be fixed on the housing by a force directly pressing the spring fastening members toward the housing. Accordingly, the difficulty of the assembling process thereof can be reduced and the assembling time can be decreased, which can effectively increase the work efficiency and reduce the manpower cost. In one embodiment, the output cable can be fixed by the fastening strip so as to make sure that the output cable can be stably fixed in the accommodating portion of the housing, which can reduce the material cost (reduces the number of the screws and wires of the downlight). Thus, the overall cost of the downlight can be decreased. In one embodiment, the light source board can be directly exposed in order to achieve great heat dissipation. Thus, the material consumption and the cost of the housing can be reduced.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the perspective view of the downlight having direct-pressing assembling mechanism in accordance with one embodiment of the present invention.

FIG. 2 is the exploded view of the downlight having direct-pressing assembling mechanism in accordance with one embodiment of the present invention.

FIG. 3 is the view illustrating the spring fastening members not assembled with the housing in accordance with one embodiment of the present invention.

FIG. 4 is the view illustrating the spring fastening members assembled with the housing in accordance with one embodiment of the present invention.

FIG. 5 is the enlargement view of the A portion of FIG. 4 in accordance with one embodiment of the present invention.

FIG. 6 is the exploded view illustrating the output cable not assembled with the fastening strip in accordance with one embodiment of the present invention.

FIG. 7 is the sectional view illustrating the output cable assembled with the fastening strip in accordance with one embodiment of the present invention.

FIG. 8 is the view illustrating the light source board assembled with the housing in accordance with one embodiment of the present invention.

FIG. 9 is the sectional view illustrating the light source board assembled with the housing in accordance with one embodiment of the present invention.

### DETAILED DESCRIPTION

The technical content of the present invention will become apparent by the detailed description of the following embodiments and the illustration of related drawings as follows.

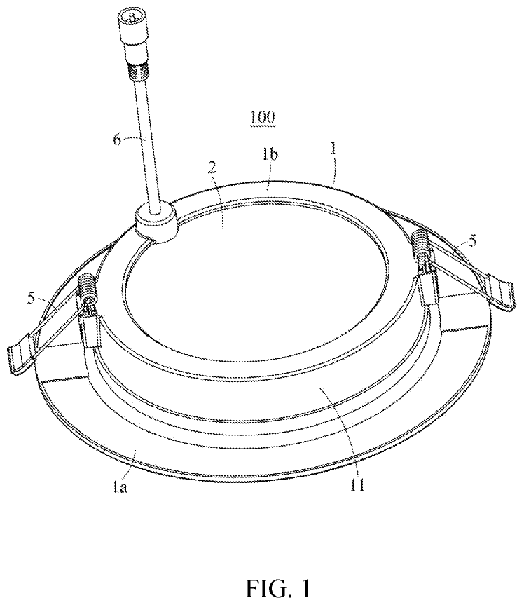

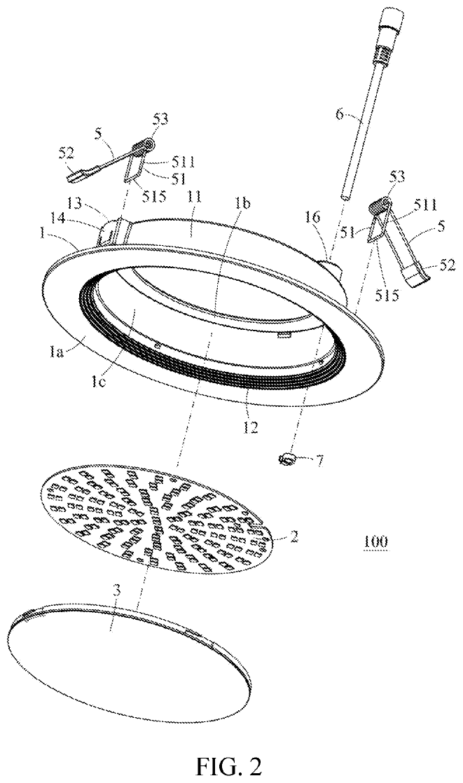

Please refer to FIG. 1 and FIG. 2. FIG. 1 is the perspective view of the downlight 100 in accordance with one embodiment of the present invention. FIG. 2 is the exploded view of the downlight 100 in accordance with one embodiment of the present invention. In one embodiment the downlight 100 having direct-pressing assembling mechanism includes a housing 1, a light source board 2, a light cover 3 and a plurality of spring fastening members 5.

Please refer to FIG. 1 and FIG. 2. In one embodiment, the structure of the housing 1 is flat and circular. The housing 1 has a cylindrical body 11, an opening 12 and a plurality of fixing portions 13. The opening 12 is disposed at one end of the cylindrical body 11. The fixing portions 13 are disposed on the outer wall of the cylindrical body 11. The inner wall of the cylindrical body 11 is inclined, so the inner diameter of the cylindrical body 11 increases from the bottom of the cylindrical body 11 to the opening 12.

Please refer to FIG. 1 and FIG. 2. In one embodiment, the light source board 2 includes a circuit board, a plurality of light-emitting elements. The light cover 3 is disposed on the cylindrical body 11 to cover the opening 12.

Please refer to FIG. 1 and FIG. 2. In one embodiment, the two ends of each of the spring fastening members 5 is provided with a supporting portion 51 and a locking portion 52 respectively. The supporting portion 51 is combined with the fixing portion 52 corresponding thereto after a force is applied to directly press the supporting portion 51 toward the fixing portion 52 corresponding thereto.

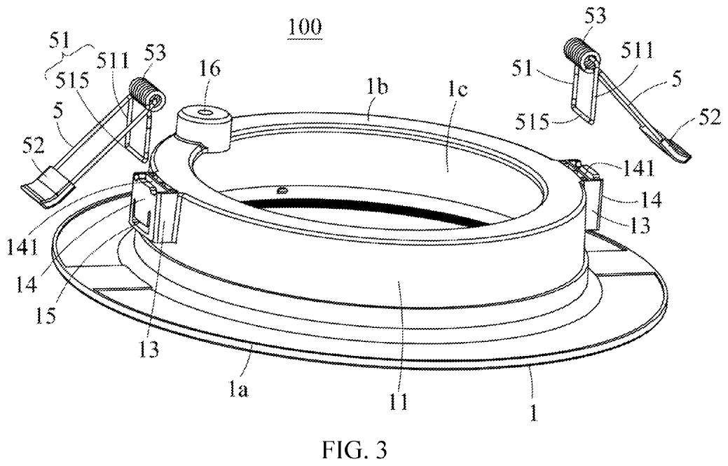

Please refer to FIG. 2 and FIG. 3. FIG. 3 is the view illustrating the spring fastening members 5 not assembled with the housing 1 in accordance with one embodiment of the present invention. In one embodiment, the housing 1 is made of heat conducting nylon material.

Please refer to FIG. 2 and FIG. 3. In one embodiment, the number of the spring fastening members 5 is 2, which are disposed and fixed on the two sides of the outer wall of the cylindrical body 11. The number of the fixing portions 13 is 2, which are disposed on the two sides of the outer wall of the cylindrical body 11. The user can conveniently and stably fix the downlight 100 in the wall hole by his/her hands via the spring fastening members 5.

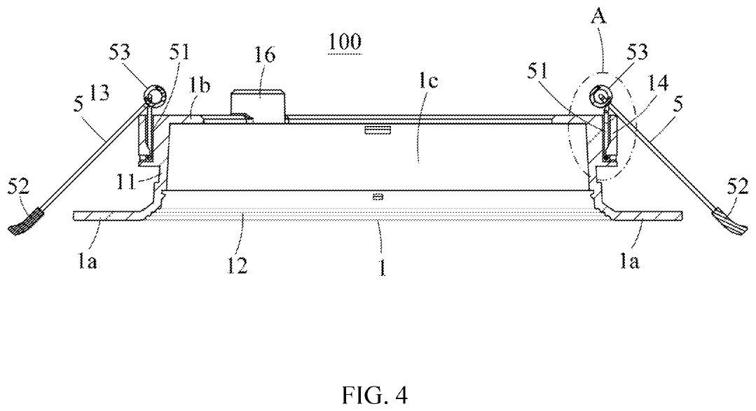

Please refer to FIG. 2 and FIG. 4. FIG. 4 is the view illustrating the spring fastening members 5 assembled with the housing 1 in accordance with one embodiment of the present invention. In one embodiment, each of the spring fastening members 5 is provided with a winding portion 53 disposed between the supporting portion 51 and the locking portion 52 thereof. The winding portion 53 is formed by a plurality of springs parallel to each other so as to provide the torsional force for the supporting portion 51 and the locking portion 52.

Please refer to FIG. 2 and FIG. 4. When the user is going to install the spring fastening members 5 at the fixing portions 13 of the housing 1, the user can align supporting portion 51 of each of the spring fastening members 5 with the fixing portion 13 corresponding thereto, and then insert the supporting portion 51 into the fixing portion 13, such that a fulcrum is formed between the spring fastening member 5 and the side wall of the housing 1. In this way, the spring fastening members 5 can provide stable fixing force to fix the downlight 100 in the wall hole. Accordingly, the spring fastening members 5 can be combined with the fixing portions 13 via the direct-press assembling mechanism, so the user can conveniently assemble the downlight 100 in order to reduce the assembling time and manpower cost.

Please refer to FIG. 2 and FIG. 4. In one embodiment, the fixing portion 13 has a protrusion block 14, a vertical locking slot 141 disposed at the protrusion block 14 and an assembling inlet 142. The assembling inlet 142 is connected to the vertical locking slot 141. The inserting direction of the vertical locking slot 141 is parallel to the installation direction of installing the downlight 100 in the wall hole.

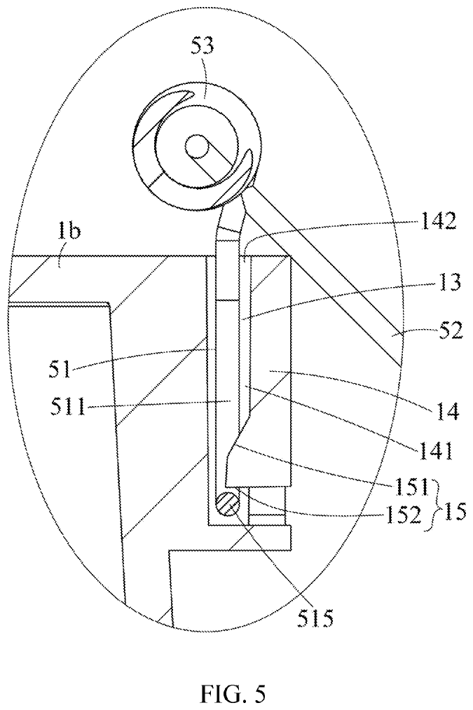

Please refer to FIG. 3 and FIG. 5. FIG. 5 is the enlargement view of the A portion of FIG. 4 in accordance with one embodiment of the present invention. In one embodiment, the protrusion block 14 has a stopper 15 extending into the vertical locking slot 141. The supporting portion 51 has two vertical bars 511 and a horizontal bar 515 connected to one end of each of the vertical bars 511. When the horizontal bar 515 is engaged with the stopper 15, the width of a portion, for accommodating the stopper 15, of the vertical locking slot 141 is less than the width of the horizontal bar 515, which can make sure that the supporting portion 51 of each of the spring fastening members 5 can be fixed at the fixing portion 13. Further, the width of the assembling inlet 142 of the vertical locking slot 141 is greater than the width of the bottom of the vertical locking slot 141.

Please refer to FIG. 3 and FIG. 5. In one embodiment, the stopper 15 has an inclined surface 151 and a stopper surface 152. The inclined surface 151 is able to guide the horizontal bar 515 to reach the stopper surface 152 and the stopper surface 152 is vertical to the inserting direction of the horizontal bar 515.

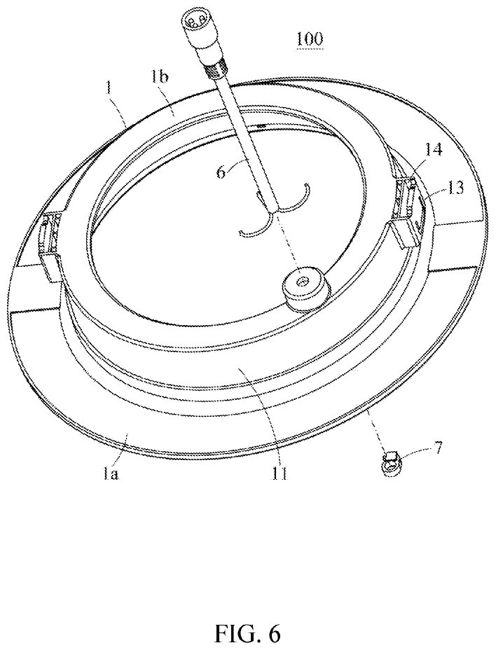

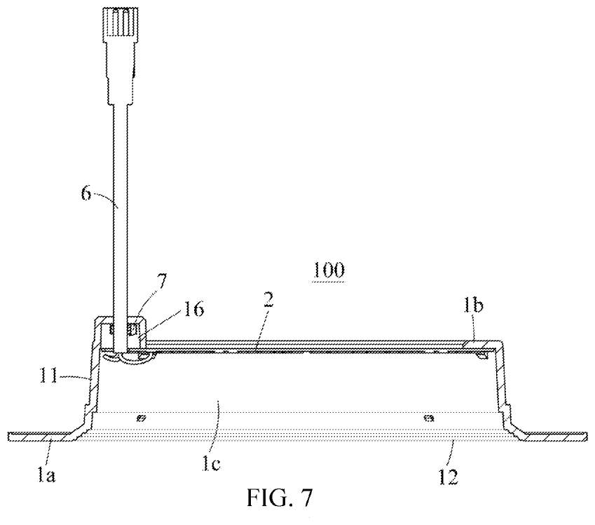

Please refer to FIG. 2, FIG. 6 and FIG. 7. FIG. 6 is the exploded view illustrating the output cable 6 not assembled with the fastening strip 7 in accordance with one embodiment of the present invention. FIG. 7 is the sectional view illustrating the output cable 6 assembled with the fastening strip 7 in accordance with one embodiment of the present invention. In one embodiment, the downlight 100 further includes an output cable 6 and a fastening strip 7. The housing 1 has an accommodating portion 16 and the output cable 6 penetrates through the cable hole of the accommodating portion 16 to connect to the light source board 2. The output cable 6 should be long enough to connect to the light source board 2. The accommodating portion 16 is a protrusion structure protruding from the housing 1 and there is a space inside the accommodating portion 16. The fastening strip 7 is disposed in the accommodating portion 16 so as to fix the output cable 6 in the accommodating portion 16. The structure of the fastening strip 7 is simple, which not only can reduce the material cost and easy to install, but also can conform to the tension standard. As a result, the above structure can effectively reduce the overall cost of the downlight 100.

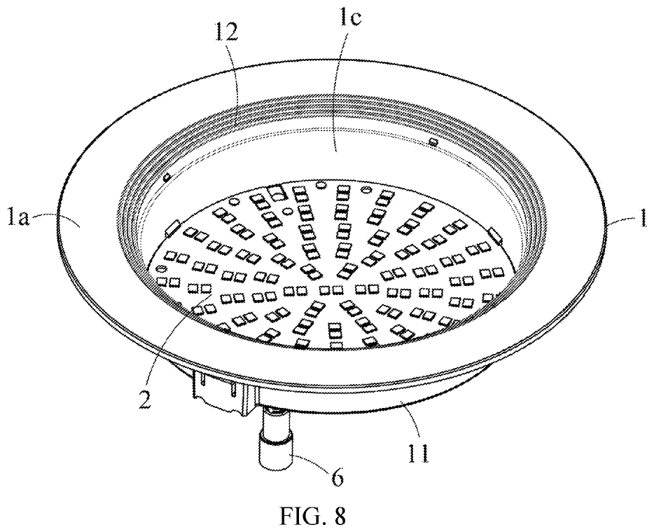

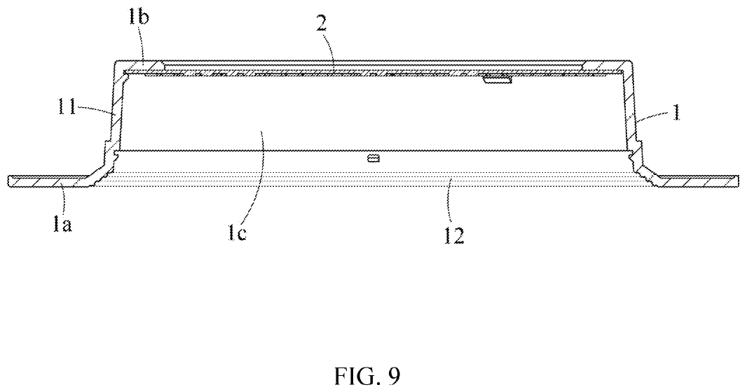

Please refer to FIG. 1, FIG. 8 and FIG. 9. FIG. 8 is the view illustrating the light source board 2 assembled with the housing 1 in accordance with one embodiment of the present invention. FIG. 9 is the sectional view illustrating the light source board 2 assembled with the housing 1 in accordance with one embodiment of the present invention. In one embodiment, the housing 1 includes a first ring portion 1a and a second ring portion 1b connected to each other. The cylindrical body 11 is disposed between the first ring portion 1a and the second ring portion 1b, such that an accommodating space 1c is formed between the first ring portion 1a, the cylindrical body 11 and the second ring portion 1b.

Please refer to FIG. 1, FIG. 8 and FIG. 9. In one embodiment, the light source board 2 is fixed on an inner surface of the second ring portion 1b and the light source board 2 is disposed in the accommodating space 1c. A portion of the light source board 2 is covered by the second ring portion 1b and the other portion of the light source board 2 is exposed from the second ring portion 1b. As the light source board 2 is exposed from the second ring portion 1b, the heat generated by the light source board 2 can dissipate in a short time. The above structure can significantly enhance the heat dissipation performance of the downlight 100 so as to avoid that the components inside the downlight 100 are deformed or deteriorate due to high temperature. As a result, the service life of the downlight 100 can be effectively increased and the performance of the downlight 100 can be also enhanced.

As set forth above, the outer edge of the light source board 2 contacts the housing 1. The housing 1 is made of a heat conducting plastic material and the thickness thereof is greater than or equal to 1.5 mm. The light source board 2 may be, but not limited to, a metal substrate, a fiberglass board or a composite-material substrate. As the light source board 2 is exposed from the second ring portion 1b, the heat generated by the light source board 2 can dissipate in a short time. In addition, the amount of the material for manufacturing the housing 1 can be reduced, so the cost of the downlight 100 can be decreased.

To sum up, according to the downlight having direct-press assembling mechanism of one embodiment of the present invention, the spring fastening members can be fixed on the housing by a force directly pressing the spring fastening members toward the housing. Accordingly, the difficulty of the assembling process thereof can be reduced and the assembling time can be decreased, which can effectively increase the work efficiency and reduce the manpower cost. In one embodiment, the output cable can be fixed by the fastening strip so as to make sure that the output cable can be stably fixed in the accommodating portion of the housing, which can reduce the material cost (reduces the number of the screws and wires of the downlight). Thus, the overall cost of the downlight can be decreased. In one embodiment, the light source board can be directly exposed in order to achieve great heat dissipation. Thus, the material consumption and the cost of the housing can be reduced.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

1. A downlight having direct-press assembling mechanism, comprising:
a housing having a cylindrical body, an opening disposed at one end of the cylindrical body, a plurality of fixing portions disposed on an outer wall of the cylindrical body, a first ring portion and a second ring portion, wherein the cylindrical body is disposed between the first ring portion and the second ring portion, whereby an accommodating space is formed between the first ring portion, the cylindrical body and the second ring portion;
a light source board fixed on an inner surface of the second ring portion and disposed inside the accommodating space, wherein a portion of the light source board is covered by the second ring portion and the other portion of the light source board is exposed from the second ring portion;
a light cover disposed on the cylindrical body to cover the opening; and
a plurality of spring fastening members, wherein two ends of each of the spring fastening members is provided with a supporting portion and a locking portion respectively, and the supporting portion is combined with the fixing portion corresponding thereto after a force is applied to directly press the supporting portion toward the fixing portion corresponding thereto.

2. The downlight having direct-press assembling mechanism as claimed in claim 1, wherein each of the spring fastening members is provided with a winding portion disposed between the supporting portion and the locking portion thereof.

3. The downlight having direct-press assembling mechanism as claimed in claim 2, wherein the fixing portion has a protrusion block, a vertical locking slot disposed at the protrusion block and an assembling inlet, wherein the assembling inlet is connected to the vertical locking slot.

4. The downlight having direct-press assembling mechanism as claimed in claim 3, wherein the protrusion block has a stopper extending into the vertical locking slot, and the supporting portion has two vertical bars and a horizontal bar connected to one end of each of the two vertical bars, wherein the horizontal bar is engaged with the stopper.

5. The downlight having direct-press assembling mechanism as claimed in claim 4, wherein a width of a portion, for accommodating the stopper, of the vertical locking slot is less than a width of the horizontal bar.

6. The downlight having direct-press assembling mechanism as claimed in claim 4, wherein the stopper has an inclined surface and a stopper surface, and the inclined surface is able to guide the horizontal bar to reach the stopper surface.

7. The downlight having direct-press assembling mechanism as claimed in claim 1, further comprising an output cable and a fastening strip, wherein the housing has an accommodating portion and the output cable penetrates through a cable hole of the accommodating portion to connect to the light source board, wherein the fastening strip is disposed in the accommodating portion to fix the output cable in the accommodating portion.

8. (canceled)

9. (canceled)

10. The downlight having direct-press assembling mechanism as claimed in claim 1, wherein the housing is made of heat-conducting nylon material.
